(19) United States
(12) Patent Application Publication
(10) Pub. No.: US 2025/0141985 A1
(43) Pub. Date: May 1, 2025

(54) DATA PARSING, TRANSMISSION AND DISPLAY METHODS, APPARATUSES, ELECTRONIC DEVICE AND STORAGE MEDIUM

(71) Applicant: Lemon Inc., Grand Cayman (KY)

(72) Inventors: Yifan YANG, Beijing (CN); Lei MA, Beijing (CN); Hailin WEN, Beijing (CN)

(21) Appl. No.: 18/927,747

(22) Filed: Oct. 25, 2024

(30) Foreign Application Priority Data
Oct. 26, 2023 (CN) 202311403101.9

(51) Int. Cl. H04L 69/22

(52) U.S. Cl. CPC H04L 69/22

(57) ABSTRACT

The embodiments of the disclosure disclose a data parsing, transmission and display method, an apparatus, an electronic device and a storage medium. The method includes: receiving a header parameter part of target data, and parsing the header parameter part to obtain a general parameter and a target object of a predefined list type; receiving at least one of list parameter parts of the target data, and parsing the at least one received list parameter part to obtain a list parameter; wherein the list parameter, after being added to the target object, is configured to render at least partial page content corresponding to the target data with the general parameter.

### CROSS-REFERENCE

This application claims priority to Chinese Patent Application No. 202311403101.9 filed on Oct. 26, 2023, and entitled “DATA PARSING, TRANSMISSION AND DISPLAY METHODS, APPARATUSES, ELECTRONIC DEVICE AND STORAGE MEDIUM”.

### FIELD

The embodiments of the present disclosure relate to the technical field of computers, in particular to data parsing, transmission and display methods, an apparatuses, an electronic device and a storage medium.

### BACKGROUND

Currently, after a client sends a data request to a server, the received data is generally in a serialized data format. Serialized data needs to be parsed only when data transmission is complete, and can be used as valid data after all parsing is completed.

When the serialized data is the structured data of the list type, the time consumed for displaying the first data in the list on the page is long, and the user experience is poor. In addition, when transmission error or parsing failure of any piece of data occurs in the list, other transmitted or parsed data cannot be used.

### SUMMARY

The embodiments of the present disclosure provide a data parsing, transmission and display method, an apparatus, an electronic device and a storage medium. The decoupling of transmission and parsing process between each piece of data in the structured data of list type can be realized, the first piece of data can be quickly displayed on the page, and the transmission and parsing process of other data is not influenced in the case of transmission error and parsing failure of data.

In a first aspect, embodiments of the present disclosure provide a method of data parsing, comprising:
receiving a header parameter part of target data, and parsing the header parameter part to obtain a general parameter and a target object of a predefined list type;
receiving at least one of list parameter parts of the target data, and parsing the at least one received list parameter part to obtain a list parameter;
wherein the list parameter, after being added to the target object, is configured to render at least partial page content corresponding to the target data with the general parameter.

In a second aspect, embodiments of the present disclosure provide a method of data transmission, comprising:
in response to a received data obtaining request, generating target data comprising a header parameter part and at least one list parameter part, wherein the header parameter part comprises a general parameter and a target object of a predefined list type;
transmitting the header parameter part to a requesting terminal of the data obtaining request;
in response to completing the transmission of the head parameter part, transmitting the at least one list parameter part to the request terminal.

In a third aspect, embodiments of the present disclosure provide a method of data display, comprising:
generating a content obtaining request based on a general parameter and at least one set of list parameters in a target object of a predefined list type, wherein the general parameter and the target object are obtained by parsing a header parameter part of received target data, and the at least one set of list parameters are obtained based on at least one list parameter part of the target data;
sending a content obtaining request to a target server, to cause the target server to feed back corresponding content data;
receiving the content data, and rendering the content data into a page for display.

In a fourth aspect, embodiments of the present disclosure further provide apparatus for data parsing, comprising:
a header parsing module configured to receive a header parameter part of target data, and parse the header parameter part to obtain a general parameter and a target object of a predefined list type;
a list parsing module configured to receive at least one of list parameter parts of the target data, and parse the received list parameter part to obtain a list parameter;
wherein the list parameter, after being added to the target object, is configured to render at least partial page content corresponding to the target data with the general parameter.

In a fifth aspect, embodiments of the present disclosure further provide an apparatus for data transmission, comprising:
a data generation module configured to generate, in response to a received data obtaining request, target data comprising a header parameter part and at least one list parameter part, wherein the header parameter part comprises a general parameter and a target object of a predefined list type;
a header transmission module configured to transmit the header parameter part to a request terminal of the data obtaining request;
a list transmission module configured to transmit, in response to completing transmission of the head parameter part, the at least one list parameter part to the request terminal.

According to a sixth aspect, embodiments of the present disclosure further provides an apparatus for data display, comprising:
a content request generation module configured to generate a content obtaining request according to a general parameter and at least one set of list parameters in a target object of a predefined list type, wherein the general parameter and the target object are obtained by parsing a header parameter part of received target data, and the at least one set of list parameters are obtained based on at least one list parameter part of the target data;
a content request sending module configured to send a content obtaining request to a target server, to cause the target server to feed back corresponding content data;
a display module configured to receive the content data, and render the content data into a page for display.

According to a seventh aspect, embodiments of the present disclosure further provide an electronic device, comprising:
one or more processors;
a storage device configured to store one or more programs;
the one or more programs, when executed by the one or more processors, causing the one or more processors to implement the method according to any one of the embodiments of the present disclosure.

In an eighth aspect, embodiments of the present disclosure further provide a storage medium comprising computer-executable instructions, wherein the computer-executable instructions, when executed by a computer processor, are configured to perform the method according to any one of the embodiments of the present disclosure.

In the technical scheme of the embodiments of the present disclosure, the method of data parsing comprises the following steps: receiving a header parameter part of target data, and parsing the header parameter part to obtain a general parameter and a target object of a predefined list type; receiving at least one of list parameter parts of the target data, and parsing the at least one received list parameter part to obtain a list parameter; wherein the list parameter, after being added to the target object, is configured to render at least partial page content corresponding to the target data with the general parameter.

By defining the list type in the transmission protocol in advance, list parameters with consistent data structure can be split out as list parameter parts of the structured data in the serialization process, and the remaining general parameters and fields indicating the list type are used as header parameter parts, so as to realize decoupling of the data of list type. Therefore, in the data parsing process, in the case of parsing the general parameters and the fields of list type (i.e. target objects) of the header parameter part, the list parameter can be quickly parsed and added to the target object once any list parameter part is received, so that the list parameter can be used in combination with the general parameter as complete and valid data. Therefore, the decoupling of transmission and parsing process between each piece of data in the structured data of list type can be realized, the first piece of data can be quickly displayed on the page, and the transmission and parsing process of other data is not influenced in the case of transmission error and parsing failure of data.

### BRIEF DESCRIPTION OF DRAWINGS

The above and other features, advantages, and aspects of various embodiments of the present disclosure will become more apparent from the following detailed description taken in conjunction with the accompanying drawings. Throughout the drawings, the same or similar reference numbers refer to the same or similar elements. It should be understood that the drawings are schematic, and components and elements are not necessarily drawn to scale.

FIG. 1 is a schematic flowchart of a method of data parsing according to an embodiment of the present disclosure;

FIG. 2 is a schematic structural diagram of target data in a method of data parsing according to an embodiment of the present disclosure;

FIG. 3 is a schematic flowchart of a method of data transmission according to an embodiment of the present disclosure;

FIG. 4 is a schematic flowchart of a method of data display according to an embodiment of the present disclosure;

FIG. 5 is a schematic structural diagram of an apparatus for data parsing according to an embodiment of the present disclosure;

FIG. 6 is a schematic structural diagram of an apparatus for data transmission according to an embodiment of the present disclosure;

FIG. 7 is a schematic structural diagram of an apparatus for data display according to an embodiment of the present disclosure;

FIG. 8 is a schematic structural diagram of an electronic device according to an embodiment of the present disclosure.

### DETAILED DESCRIPTION

Embodiments of the present disclosure will be described in more detail below with reference to the accompanying drawings. While certain embodiments of the present disclosure are shown in the drawings, it is to be understood that the present disclosure may be implemented in various forms, and should not be construed as limited to the embodiments set forth herein, and vice versa. It should be understood that the drawings and embodiments of the present disclosure are for exemplary purposes only and are not intended to limit the scope of the present disclosure.

It should be understood that the steps recited in the method embodiments of the present disclosure may be performed in different orders, and/or in parallel. Further, the method embodiments may include additional steps and/or omit performing the illustrated steps. The scope of the present disclosure is not limited in this respect.

As used herein, the term “comprising” and deformation thereof are open-ended, i.e., “including but not limited to”. The term “based on” is “based at least in part on”. The term “one embodiment” means “at least one embodiment”; the term “another embodiment” means “at least one further embodiment”; the term “some embodiments” means “at least some embodiments”. The relevant definition of other terms will be given below.

It should be noted that concepts such as “first” and “second” mentioned in this disclosure are merely used to distinguish different apparatuses, modules, or units, and are not intended to limit the order of functions performed by the apparatuses, modules, or units or the mutual dependency relationship.

It should be noted that the modification of “a” and “a plurality” mentioned in this disclosure is illustrative and not limiting, and those skilled in the art should understand that “one or more” should be understood unless the context clearly indicates otherwise.

The names of messages or information interaction between multiple devices in embodiments of the present disclosure are for illustrative purposes only and are not intended to limit the scope of such messages or information.

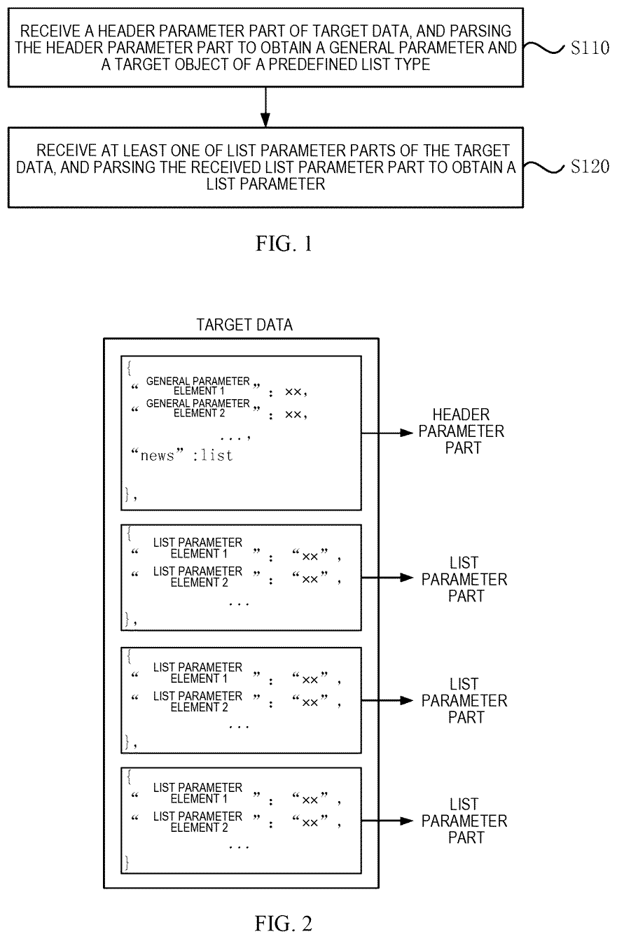

FIG. 1 is a schematic flowchart of a method of data parsing according to an embodiment of the present disclosure. The embodiment of the present disclosure is suitable for a case of parsing the structured data of list type. The method may be performed by an apparatus for data parsing, and the apparatus may be implemented in a form of software and/or hardware, and may be integrated in a client and installed in an electronic device with a client, for example, installed in a device such as a computer or a mobile phone.

As shown in FIG. 1, the method of data parsing provided in the embodiment may include the following steps.

S110: receive a header parameter part of target data, and parse the header parameter part to obtain a general parameter and a target object of a predefined list type.

S120: receive at least one of list parameter parts of the target data, and parse the at least one received list parameter part to obtain a list parameter.

The list parameter, after being added to the target object, is configured to render at least partial page content corresponding to the target data with the general parameter.

In the embodiments of the present disclosure, the target data belongs to structured data of a list type. The structured data of the list type may be considered as data including at least one set of list parameters, where elements included in each set of list parameters are the same, and formats of the elements are also the same. At least one set of list parameters of the target data may be included in the at least one list parameter parts.

The target data may further include data with a non-list parameter, the data with the non-list parameter in the embodiment may include the general parameter and field data of a predefined list type (that is, the target object), and the non-list parameter may be included in the head parameter part. The general parameter may include an element part having a same value extracted from each set of list parameters. A general parameter may be considered to be combined with any list parameter to constitute valid data that can be used. The list type may be a data type predefined in the data transmission protocol, and the identifier may be defined to represent the list type in the predefined process. When the value corresponding to the field data is the identifier of the list type, the field data may be used as the target object.

In addition, in the data transmission protocol, it may be further defined that, when the header parameter part includes field data of the list type, a part located after the header parameter part is at least one list parameter part. Each part of the target data may be represented by a symbol such as “{ }”, and the parts may be separated by a preset separator (such as, “,”).

Correspondingly, in the process of parsing the target data, the header parameter part of the target data may be received first, and when the header parameter part of the target data is received, data parsing may be performed based on an existing reverse sequence, to obtain an element of each general parameter and a corresponding value thereof, and a target object of the list type. Then, in response to receiving any complete list parameter part, the received list parameter part is parsed based on an existing reverse sequence to obtain a list parameter part.

In the case that the target data is received and parsed asynchronously, the receiving of the next part of the target data may be continued while the previous part of the target data is parsed; in the case of synchronous execution, the receiving of the next part of the target data may be performed if the previous part of the target data is parsed successfully, which is not specifically limited herein.

After the general parameters, the target object, and any set of list parameters have been parsed, the parsed parameters in the target data can still constitute valid data that can be used, even if there is a list parameter part of the target data being transmitted and/or parsed.

In the embodiment, the parsed list parameter may be added to the target object, because the target object and the general parameter are a complete data part, the content obtaining request may be generated by using the list parameter and the general parameter in the target object, and may be sent to the server, so that the server feeds back the corresponding content data. After receiving the content data, the received content data may be rendered to the page for display based on an existing page rendering mode, so that content corresponding to the parsed list data in the target data may be displayed in the page. According to the method of data parsing provided by the embodiment, the quick display of at least partial page content corresponding to the target data can be achieved without waiting for all transmission and parsing of the target data, and the user experience can be improved.

In some alternative implementations, receiving at least one of the list parameter parts of the target data, and parsing the received list parameter part comprises at least one of the following: in response to failing to receive a current list parameter part, receiving a next list parameter part; and in response to failing to parse a currently received list parameter part, parsing a next received list parameter part.

In the alternative implementations, in response to failing to receive any list parameter part, the list parameter part may be skipped to receive the next list parameter part; and/or in response to failing to parse the currently received list parameter part, the list parameter part may be skipped to parse the next list parameter part. The transmission and parsing process of other data is not influenced in the case of transmission error and parsing failure of list parameter part.

In addition, processing may also be performed based on other policies in case of transmission error and parsing failure of data. For example, in response to failing to receive the current list parameter part, the list parameter part and the following list parameter part may be discarded; and/or, in response to failing to parse the currently received list parameter part, the list parameter part and the following list parameter part may be discarded, which is not exhaustive here.

In some alternative implementations, the method of data parsing may further include: in response to failing to receive or failing to parse a list parameter part, generating a data obtaining request based on the list parameter part that is failed to be received and/or failed to be parsed; sending the data obtaining request to a target server, to cause the target server to feed back new target data.

In the alternative implementations, the data obtaining request may also be generated based on the list parameter part of reception failure and/or the parsing failure in the case of transmission error and parsing failure of the list parameter part. For example, a data obtaining request may be generated according to a data identifier (ID) in a list parameter part of reception failure and/or parsing failure, so as to request new target data including the list parameter part of the reception failure and/or the parsing failure to the target server again.

In addition, the new target data may be requested based on other policies in a case of transmission error and data parsing failure of the list parameter part. For example, the target server may request the target data that includes any list parameter part, so that the page content is complete and the like, which is not exhaustive here.

In some implementations, the page content corresponding to the target data include at least one of a text, an image, an audio, or a video. For example, the page content corresponding to the target data may include content in the form of news, videos, comments, and the like.

For example, FIG. 2 is a schematic structural diagram of target data in a method of data parsing according to an embodiment of the present disclosure. Referring to FIG. 2, the page content corresponding to the target data may be news, parts of the target data may be represented by “{ }”, and the parts may be separated by “,”. In FIG. 2, the header parameter part in the target data may include elements of general parameters and values thereof, and news fields of a list type. In FIG. 2, after the header parameter part of the target data, three list parameter parts are included, where elements and element formats in the list parameters included in each list parameter part are the same, but the element values are not completely the same. After parsing any part of the header parameter part and the list parameter part in FIG. 2, the list parameter may be added to the news, and the relevant news content may be obtained based on the parsed element of the general parameter and the value thereof and the element and element value in the parsed list parameter, and the acquired news content may be rendered to the page for display.

According to the technical scheme of the embodiment of the present disclosure, the head parameter part of the target data is received, the head parameter part is analyzed to obtain the general parameter and the target object of the predefined list type; at least one of the list parameter part of the target data is received, and the received list parameter part is analyzed to obtain a list parameter; and after the list parameter is added to the target object, the list parameter and the general parameter are jointly used for rendering at least partial page content corresponding to the target data.

By defining the list type in the transmission protocol in advance, list parameters with consistent data structure can be split out as list parameter parts of the structured data in the serialization process, and the remaining general parameters and fields indicating the list type are used as header parameter parts, so as to realize decoupling of the data of list type. Therefore, in the data parsing process, the list parameter can be quickly parsed and added to the target object once any list parameter part is received, so that the list parameter can be used in combination with the general parameter as complete and valid data. Therefore, the decoupling of transmission and parsing process between each piece of data in the structured data of list type can be realized, the first piece of data can be quickly displayed on the page, and the transmission and parsing process of other data is not influenced in the case of transmission error and parsing failure of data.

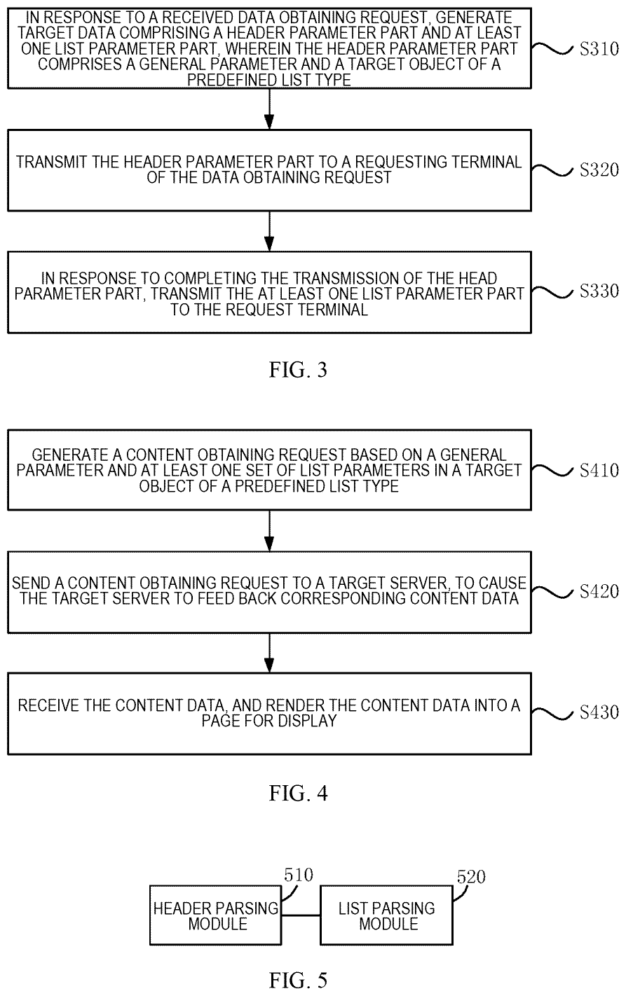

FIG. 3 is a schematic flowchart of a method of data transmission according to an embodiment of the present disclosure. The embodiment of the present disclosure is suitable for a case of transmitting the structured data of list type. The method may be performed by an apparatus for data transmission, and the apparatus may be implemented in a form of software and/or hardware, and the apparatus may be configured in an electronic device, for example, configured in a server.

As shown in FIG. 3, the method of data transmission provided in the embodiment may include the following steps.

S310: in response to a received data obtaining request, generate target data comprising a header parameter part and at least one list parameter part, wherein the header parameter part comprises a general parameter and a target object of a predefined list type.

In the embodiments of the present disclosure, the server may receive a data obtaining request sent by a requesting terminal (usually a client), and may generate target data based on the data obtaining request.

The target data belongs to structured data of a list type. The structured data of the list type may be considered as data including at least one set of list parameters, where elements included in each set of list parameters are the same, and formats of the elements are also the same. At least one set of list parameters of the target data may be included in the at least one list parameter parts.

The target data may further include data with a non-list parameter, the data with the non-list parameter in the embodiment may include the general parameter and field data of a predefined list type (that is, the target object), and the non-list parameter may be included in the head parameter part. The general parameter may include an element part having a same value extracted from each set of list parameters. A general parameter may be considered to be combined with any list parameter to constitute valid data that can be used. The list type may be a data type predefined in the data transmission protocol, and the identifier may be defined to represent the list type in the predefined process. When the value corresponding to the field data is the identifier of the list type, the field data may be used as the target object.

In addition, in the data transmission protocol, it may be further defined that, when the header parameter part includes field data of the list type, a part located after the header parameter part is at least one list parameter part. Each part of the target data may be represented by a symbol such as “{ }”, and the parts may be separated by a preset separator (such as, “,”).

S320: transmit the header parameter part to a requesting terminal of the data obtaining request.

In the embodiment of the present disclosure, the header parameter part may be serialized and transmitted to the request terminal based on an existing serialization mode, so that the requesting terminal first receives and parses the header parameter part of the target data to obtain the general parameter and the target object of the predefined list type.

S330: in response to completing the transmission of the head parameter part, transmit the at least one list parameter part to the request terminal.

When the transmission of the header parameter part is completed, each list parameter part may be serialized and transmitted to the requesting terminal based on an existing serialization mode. Therefore, after receiving at least one of the list parameter parts of the target data, the requesting terminal may parse the received list parameter part to obtain a list parameter, where after being added to the target object, the list parameter is used together with the general parameter to render at least partial page content corresponding to the target data.

According to the technical scheme of the embodiment of the present disclosure, the method of data transmission includes: in response to a received data obtaining request, generating target data comprising a header parameter part and at least one list parameter part, wherein the header parameter part comprises a general parameter and a target object of a predefined list type; transmitting the header parameter part to a requesting terminal of the data obtaining request; in response to completing the transmission of the head parameter part, transmitting the at least one list parameter part to the request terminal.

By defining the list type in the transmission protocol in advance, list parameters with consistent data structure can be split out as list parameter parts of the structured data in the serialization process, and the remaining general parameters and fields indicating the list type are used as header parameter parts, so as to realize decoupling of the data of list type. Therefore, by first sending the header parameter parts and then sending each list parameter part in order, in the case that the requesting terminal parses the general parameters and the fields of list type (i.e. target objects) of the header parameter part, the list parameter can be quickly parsed and added to the target object once any list parameter part is received, so that the list parameter can be used in combination with the general parameter as complete and valid data.

In addition, the method of data transmission provided in the embodiments of the present disclosure and the method of data parsing provided in the foregoing embodiments belong to the same disclosure concept, technical details not described in detail in this embodiment may refer to the foregoing embodiments, and this embodiment has the same beneficial effects as the foregoing embodiments.

FIG. 4 is a schematic flowchart of a method of data display according to an embodiment of the present disclosure. The embodiment of the present disclosure is suitable for a case of displaying the structured data of list type. The method may be performed by an apparatus for data display, and the apparatus may be implemented in a form of software and/or hardware, and may be integrated in a client and installed in an electronic device with a client, for example, installed in a device such as a computer or a mobile phone.

As shown in FIG. 4, the method of data display provided in this embodiment may include the following steps.

S410: generate a content obtaining request based on a general parameter and at least one set of list parameters in a target object of a predefined list type.

The general parameter and the target object are obtained by parsing a header parameter part of received target data, and the at least one set of list parameters are obtained based on at least one list parameter part of the target data.

In the embodiments of the present disclosure, after the general parameters, the target object, and any set of list parameters have been parsed by the client, the parsed parameters in the target data can still constitute valid data that can be used, even if there is a list parameter part of the target data being transmitted and/or parsed.

S420: send a content obtaining request to a target server, to cause the target server to feed back corresponding content data.

In the embodiments of the present disclosure, the client may send the content obtaining request to the target server. The parsed list parameter may be added to the target object, because the target object and the general parameter are a complete data part, the content obtaining request may be generated by using the list parameter and the general parameter in the target object.

S430: receive the content data, and render the content data into a page for display.

In the embodiments of the present disclosure, after the client receives the content data, the received content data may be rendered to the page for display based on an existing page rendering mode, so that content corresponding to the parsed list data in the target data may be displayed in the page. The quick display of at least partial page content corresponding to the target data can be achieved without waiting for all transmission and parsing of the target data, and the user experience can be improved.

According to the technical scheme of the embodiment of the present disclosure, the method of data display includes: generating a content obtaining request based on a general parameter and at least one set of list parameters in a target object of a predefined list type, wherein the general parameter and the target object are obtained by parsing a header parameter part of received target data, and the at least one set of list parameters are obtained based on at least one list parameter part of the target data; sending a content obtaining request to a target server, to cause the target server to feed back corresponding content data; receiving the content data, and rendering the content data into a page for display. The quick display of at least partial page content corresponding to the target data can be achieved without waiting for all transmission and parsing of the target data, and the user experience can be improved.

In addition, the method of data display provided in the embodiments of the present disclosure and the method of data parsing and the method of data transmission provided in the foregoing embodiments belong to the same disclosure concept, and technical details not described in detail in this embodiment may refer to the foregoing embodiments, and this embodiment has the same beneficial effects as the foregoing embodiments.

FIG. 5 is a schematic structural diagram of an apparatus for data parsing according to an embodiment of the present disclosure. The apparatus for data parsing provided in this embodiment is applicable to a case in which structured data of a list type is parsed. The device may be integrated in the client and installed in the electronic device along with the client, for example, installed in a device such as a computer or a mobile phone.

As shown in FIG. 5, an apparatus for parsing data according to an embodiment of the present disclosure may include:
a header parsing module 510, configured to receive a header parameter part of target data, and parse the header parameter part to obtain a general parameter and a target object of a predefined list type;
a list parsing module 520 is configured to receive at least one of list parameter parts of the target data, and parse the received list parameter part to obtain a list parameter.

The list parameter, after being added to the target object, is configured to render at least partial page content corresponding to the target data with the general parameter.

In some alternative implementations, the list parsing module may be configured to at least one of the following:
in response to failing to receive a current list parameter part, receive a next list parameter part;
in response to failing to parse a currently received list parameter part, parse a next received list parameter part.

In some alternative implementations, the apparatus for data parsing may further include:
a data request generation module, configured to, in response to failing to receive or failing to parse a list parameter part, generate a data obtaining request based on the list parameter part that is failed to be received and/or failed to be parsed;
a data request sending module, configured to send the data obtaining request to a target server, to cause the target server to feed back new target data.

In some alternative implementations, the page content corresponding to the target data comprises at least one of a text, an image, an audio, or a video.

The apparatus for data parsing provided in the embodiments of the present disclosure may perform the method of data parsing provided by any embodiment of the present disclosure, and has functional modules and beneficial effects corresponding to the execution method.

It should be noted that the units and modules included in the foregoing apparatus are only divided according to the function logic, but are not limited to the foregoing division, as long as the corresponding functions can be implemented; in addition, the specific names of the functional units are merely for ease of distinguishing, and are not intended to limit the protection scope of the embodiments of the present disclosure.

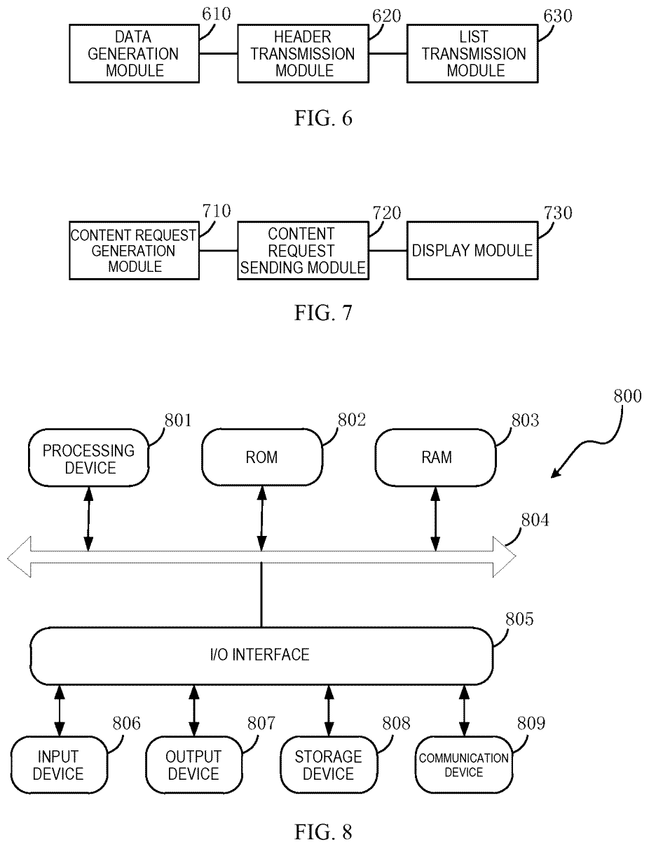

FIG. 6 is a schematic structural diagram of an apparatus for data transmission according to an embodiment of the present disclosure. The apparatus for data transmission provided in this embodiment is applicable to a case of transmitting structured data of a list type. The apparatus may be configured in an electronic device, for example, configured in a server.

As shown in FIG. 6, an apparatus for data transmission according to an embodiment of the present disclosure may include:
a data generation module 610, configured to generate, in response to a received data obtaining request, target data comprising a header parameter part and at least one list parameter part, wherein the header parameter part comprises a general parameter and a target object of a predefined list type.
a header transmission module 620, configured to transmit the header parameter part to a request terminal of the data obtaining request.
a list transmission module 630, configured to transmit, in response to completing transmission of the head parameter part, the at least one list parameter part to the request terminal.

The apparatus for data transmission provided in the embodiments of the present disclosure may perform the method of data transmission provided by any embodiment of the present disclosure, and has functional modules and beneficial effects corresponding to the execution method.

It should be noted that the units and modules included in the foregoing apparatus are only divided according to the function logic, but are not limited to the foregoing division, as long as the corresponding functions can be implemented; in addition, the specific names of the functional units are merely for ease of distinguishing, and are not intended to limit the protection scope of the embodiments of the present disclosure.

FIG. 7 is a schematic structural diagram of an apparatus for data display according to an embodiment of the present disclosure. The apparatus for data display provided in this embodiment is applicable to a case of displaying structured data of a list type. The device may be integrated in the client and installed in the electronic device along with the client, for example, installed in a device such as a computer or a mobile phone.

As shown in FIG. 7, an apparatus for data display according to an embodiment of the present disclosure may include:
a content request generation module 710, configured to generate a content obtaining request according to a general parameter and at least one set of list parameters in a target object of a predefined list type, wherein the general parameter and the target object are obtained by parsing a header parameter part of received target data, and the at least one set of list parameters are obtained based on at least one list parameter part of the target data; and
a content request sending module 720, configured to send a content obtaining request to a target server, to cause the target server to feed back corresponding content data;
a display module 730, configured to receive the content data, and render the content data into a page for display.

The apparatus for data display provided by the embodiments of the present disclosure may perform the method of data display provided by any embodiment of the present disclosure, and has functional modules and beneficial effects corresponding to the execution method.

It should be noted that the units and modules included in the foregoing apparatus are only divided according to the function logic, but are not limited to the foregoing division, as long as the corresponding functions can be implemented; in addition, the specific names of the functional units are merely for ease of distinguishing, and are not intended to limit the protection scope of the embodiments of the present disclosure.

FIG. 8 is a schematic structural diagram of an electronic device (such as the terminal device or server in FIG. 8) suitable for implementing the embodiments of the present disclosure. The terminal device in the embodiments of the present disclosure may include, but is not limited to, a mobile terminal such as a mobile phone, a notebook computer, a digital broadcast receiver, a PDA (personal digital assistant), a PAD (tablet computer), a PMP (portable multimedia player), an in-vehicle terminal (for example, an in-vehicle navigation terminal), and a fixed terminal such as a digital TV, a desktop computer, or the like. The electronic device shown in FIG. 8 is merely an example, and should not impose any limitation on the functions and scope of use of the embodiments of the present disclosure.

As shown in FIG. 8, the electronic device 800 may include a processing device (for example, a central processing unit, a graphics processor, etc.) 801, which may perform various appropriate actions and processing according to a program stored in a read-only memory (ROM) 802 or a program loaded into a random access memory (RAM) 803 from a storage device 808. In the RAM 803, various programs and data required by the operation of the electronic device 800 are also stored. The processing device 801, the ROM 802, and the RAM 803 are connected to each other through a bus 804. Input/output (I/O) interface 805 is also connected to bus 804.

Generally, the following devices may be connected to the I/O interface 805: an input device 806 including, for example, a touch screen, a touchpad, a keyboard, a mouse, a camera, a microphone, an accelerometer, a gyroscope, etc.; an output device 807 including, for example, a liquid crystal display (LCD), a speaker, a vibrator, etc.; a storage device 808 including, for example, a magnetic tape, a hard disk, etc.; and a communication device 809. The communication device 809 may allow the electronic device 800 to communicate wirelessly or wired with other devices to exchange data. While FIG. 8 shows an electronic device 800 having various devices, it should be understood that it is not required to implement or have all illustrated devices. More or fewer devices may alternatively be implemented or provided.

In particular, according to an embodiment of the present disclosure, the process described above with reference to the flowchart may be implemented as a computer software program. For example, embodiments of the present disclosure include a computer program product comprising a computer program embodied on a non-transitory computer readable medium, the computer program comprising program code for performing the method shown in the flowchart. In such embodiments, the computer program may be downloaded and installed from the network through the communication device 809, or installed from the storage device 808, or installed from ROM 802. When the computer program is executed by the processing apparatus 801, the foregoing functions defined in the method for parsing, transmitting, or displaying data in the embodiments of the present disclosure are performed.

The electronic device provided by the embodiments of the present disclosure and the method of data parsing, the method of data transmission and the method of data display provided in the foregoing embodiments belong to the same disclosure concept, and technical details not described in detail in this embodiment may refer to the foregoing embodiments, and this embodiment has the same beneficial effects as the foregoing embodiments.

An embodiment of the present disclosure provides a computer storage medium, where a computer program is stored, and when the program is executed by a processor, the data parsing, data transmission or method of data display provided in the foregoing embodiments is implemented.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, device, or device, or any combination thereof. More specific examples of the computer-readable storage medium may include, but are not limited to, an electrical connection having one or more wires, a portable computer diskette, a hard disk, a random access memory (RAM), a read-only memory (ROM), an erasable programmable read-only memory (EPROM) or a flash memory (FLASH), an optical fiber, a portable compact disk read-only memory (CD-ROM), an optical storage device, a magnetic storage device, or any suitable combination thereof. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, including, but not limited to: wires, optical cables, RF (radio frequency), and the like, or any suitable combination of the foregoing.

In some implementations, the client, server may communicate using any currently known or future developed network protocol, such as HTTP (Hyper Text Transfer Protocol), and may be interconnected with any form or medium of digital data communication (e.g., communication network). Examples of communication networks include local area networks (“LANs”), wide area networks (“WANs”), internets (e.g., the Internet), and peer-to-peer networks (e.g., ad hoc peer-to-peer networks), as well as any currently known or future developed networks.

The computer-readable medium described above may be included in the electronic device; or may be separately present without being assembled into the electronic device.

The computer-readable medium carries one or more programs, and when the one or more programs are executed by the electronic device, the electronic device is caused to:
receive a header parameter part of target data, and parsing the header parameter part to obtain a general parameter and a target object of a predefined list type; receive at least one of list parameter parts of the target data, and parsing the at least one received list parameter part to obtain a list parameter; wherein the list parameter, after being added to the target object, is configured to render at least partial page content corresponding to the target data with the general parameter.

Alternatively, the computer-readable medium carries one or more programs, and when the one or more programs are executed by the electronic device, the electronic device is caused to:
in response to a received data obtaining request, generate target data comprising a header parameter part and at least one list parameter part, wherein the header parameter part comprises a general parameter and a target object of a predefined list type; transmit the header parameter part to a requesting terminal of the data obtaining request; in response to completing the transmission of the head parameter part, transmit the at least one list parameter part to the request terminal.

Alternatively, the computer-readable medium carries one or more programs, and when the one or more programs are executed by the electronic device, the electronic device is caused to: generate a content obtaining request based on a general parameter and at least one set of list parameters in a target object of a predefined list type, wherein the general parameter and the target object are obtained by parsing a header parameter part of received target data, and the at least one set of list parameters are obtained based on at least one list parameter part of the target data; send a content obtaining request to a target server, to cause the target server to feed back corresponding content data; receive the content data, and rendering the content data into a page for display.

Computer program code for performing the operations of the present disclosure may be written in one or more programming languages, including, but not limited to, object oriented programming languages such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (e.g., connected through the Internet using an Internet service provider).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or part of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. A name of a unit and a module does not constitute a limitation on the unit and the module in some cases.

The functions described above may be performed, at least in part, by one or more hardware logic components. For example, without limitation, the exemplary types of hardware logic components that may be used include: a field programmable gate array (FPGA), an application specific integrated circuit (ASIC), an application specific standard (ASSP), a system on chip (SOC), a complex programmable logic device (CPLD), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

According to one or more embodiments of the present disclosure, a method of data parsing is provided in Example 1. The method includes:
receiving a header parameter part of target data, and parsing the header parameter part to obtain a general parameter and a target object of a predefined list type;
receiving at least one of list parameter parts of the target data, and parsing the at least one received list parameter part to obtain a list parameter;
wherein the list parameter, after being added to the target object, is configured to render at least partial page content corresponding to the target data with the general parameter.

According to one or more embodiments of the present disclosure, a method of data parsing is provided in Example 2. The method further includes:
in some alternative implementations, receiving at least one of the list parameter parts of the target data, and parsing the received list parameter part comprises at least one of the following:
in response to failing to receive a current list parameter part, receiving a next list parameter part;
in response to failing to parse a currently received list parameter part, parsing a next received list parameter part.

According to one or more embodiments of the present disclosure, a method of data parsing is provided. The method further includes:
in some alternative implementations, in response to failing to receive or failing to parse a list parameter part, generating a data obtaining request based on the list parameter part that is failed to be received and/or failed to be parsed;
sending the data obtaining request to a target server, to cause the target server to feed back new target data.

According to one or more embodiments of the present disclosure, a method of data parsing is provided in Example 4. The method further includes:
in some alternative implementations, the page content corresponding to the target data comprises at least one of a text, an image, an audio, or a video.

According to one or more embodiments of the present disclosure, a method of data transmission is provided in Example 5. The method includes:
in response to a received data obtaining request, generating target data comprising a header parameter part and at least one list parameter part, wherein the header parameter part comprises a general parameter and a target object of a predefined list type;
transmitting the header parameter part to a requesting terminal of the data obtaining request;
in response to completing the transmission of the head parameter part, transmitting the at least one list parameter part to the request terminal.

According to one or more embodiments of the present disclosure, a method of data display is provided in Example 6. The method includes:
generating a content obtaining request based on a general parameter and at least one set of list parameters in a target object of a predefined list type, wherein the general parameter and the target object are obtained by parsing a header parameter part of received target data, and the at least one set of list parameters are obtained based on at least one list parameter part of the target data;
sending a content obtaining request to a target server, to cause the target server to feed back corresponding content data;
receiving the content data, and rendering the content data into a page for display.

According to one or more embodiments of the present disclosure, an apparatus for data parsing is provided in Example 7. The apparatus includes:
a header parsing module, configured to receive a header parameter part of target data, and parse the header parameter part to obtain a general parameter and a target object of a predefined list type;
a list parsing module, configured to receive at least one of list parameter parts of the target data, and parse the received list parameter part to obtain a list parameter;
wherein the list parameter, after being added to the target object, is configured to render at least partial page content corresponding to the target data with the general parameter.

According to one or more embodiments of the present disclosure, a data transmission apparatus is provided in Example 8. The apparatus includes:
a data generation module, configured to generate, in response to a received data obtaining request, target data comprising a header parameter part and at least one list parameter part, wherein the header parameter part comprises a general parameter and a target object of a predefined list type;
a header transmission module, configured to transmit the header parameter part to a request terminal of the data obtaining request;
a list transmission module, configured to transmit, in response to completing transmission of the head parameter part, the at least one list parameter part to the request terminal.

According to one or more embodiments of the present disclosure, an apparatus for data display is provided in Example 9. The apparatus includes:
a content request generation module, configured to generate a content obtaining request according to a general parameter and at least one set of list parameters in a target object of a predefined list type, wherein the general parameter and the target object are obtained by parsing a header parameter part of received target data, and the at least one set of list parameters are obtained based on at least one list parameter part of the target data; and
a content request sending module, configured to send a content obtaining request to a target server, to cause the target server to feed back corresponding content data;
a display module, configured to receive the content data, and render the content data into a page for display.

The above description is merely an illustration of the preferred embodiments of the present disclosure and the principles of the application. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept. For example, the above features are the technical solutions formed by mutually replacing technical features disclosed in the present disclosure (but not limited to).

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

I/We claim:

1. A method of data parsing, comprising:
receiving a header parameter part of target data, and parsing the header parameter part to obtain a general parameter and a target object of a predefined list type;
receiving at least one of list parameter parts of the target data, and parsing the received list parameter part to obtain a list parameter;
wherein the list parameter, after being added to the target object, is configured to render at least partial page content corresponding to the target data with the general parameter.

2. The method of claim 1, wherein receiving at least one of the list parameter parts of the target data, and parsing the received list parameter part comprises at least one of the following:
in response to failing to receive a current list parameter part, receiving a next list parameter part;
in response to failing to parse a currently received list parameter part, parsing a next received list parameter part.

3. The method of claim 2, further comprising:
in response to failing to receive or failing to parse a list parameter part, generating a data obtaining request based on the list parameter part that is failed to be received and/or failed to be parsed;
sending the data obtaining request to a target server, to cause the target server to feed back new target data.

4. The method of claim 1, wherein the page content corresponding to the target data comprises at least one of a text, an image, an audio, or a video.

5. A method of data transmission, comprising:
in response to a received data obtaining request, generating target data comprising a header parameter part and at least one list parameter part, wherein the header parameter part comprises a general parameter and a target object of a predefined list type;
transmitting the header parameter part to a requesting terminal of the data obtaining request;
in response to completing the transmission of the head parameter part, transmitting the at least one list parameter part to the request terminal.

6. A method of data display, comprising:
generating a content obtaining request based on a general parameter and at least one set of list parameters in a target object of a predefined list type, wherein the general parameter and the target object are obtained by parsing a header parameter part of received target data, and the at least one set of list parameters are obtained based on at least one list parameter part of the target data;
sending a content obtaining request to a target server, to cause the target server to feed back corresponding content data;
receiving the content data, and rendering the content data into a page for display.

7. An electronic device, comprising:
one or more processors;
a storage device configured to store one or more programs;
the one or more programs, when executed by the one or more processors, causing the one or more processors to implement acts comprising:
receiving a header parameter part of target data, and parsing the header parameter part to obtain a general parameter and a target object of a predefined list type;
receiving at least one of list parameter parts of the target data, and parsing the received list parameter part to obtain a list parameter;
wherein the list parameter, after being added to the target object, is configured to render at least partial page content corresponding to the target data with the general parameter.

8. The electronic device of claim 7, wherein receiving at least one of the list parameter parts of the target data, and parsing the received list parameter part comprises at least one of the following:
in response to failing to receive a current list parameter part, receiving a next list parameter part;
in response to failing to parse a currently received list parameter part, parsing a next received list parameter part.

9. The electronic device of claim 8, wherein the acts further comprise:
in response to failing to receive or failing to parse a list parameter part, generating a data obtaining request based on the list parameter part that is failed to be received and/or failed to be parsed;
sending the data obtaining request to a target server, to cause the target server to feed back new target data.

10. The electronic device of claim 7, wherein the page content corresponding to the target data comprises at least one of a text, an image, an audio, or a video.

11. An electronic device, comprising:
one or more processors;
a storage device configured to store one or more programs;
the one or more programs, when executed by the one or more processors, causing the one or more processors to implement acts comprising:
in response to a received data obtaining request, generating target data comprising a header parameter part and at least one list parameter part, wherein the header parameter part comprises a general parameter and a target object of a predefined list type;
transmitting the header parameter part to a requesting terminal of the data obtaining request;
in response to completing the transmission of the head parameter part, transmitting the at least one list parameter part to the request terminal.

12. An electronic device, comprising:
one or more processors;
a storage device configured to store one or more programs;
the one or more programs, when executed by the one or more processors, causing the one or more processors to implement acts comprising:
generating a content obtaining request based on a general parameter and at least one set of list parameters in a target object of a predefined list type, wherein the general parameter and the target object are obtained by parsing a header parameter part of received target data, and the at least one set of list parameters are obtained based on at least one list parameter part of the target data;
sending a content obtaining request to a target server, to cause the target server to feed back corresponding content data;
receiving the content data, and rendering the content data into a page for display.

13. A non-transitory storage medium comprising computer-executable instructions, wherein the computer-executable instructions, when executed by a computer processor, are configured to implement acts comprising:
receiving a header parameter part of target data, and parsing the header parameter part to obtain a general parameter and a target object of a predefined list type;
receiving at least one of list parameter parts of the target data, and parsing the received list parameter part to obtain a list parameter;
wherein the list parameter, after being added to the target object, is configured to render at least partial page content corresponding to the target data with the general parameter.

14. The non-transitory storage medium of claim 13, wherein receiving at least one of the list parameter parts of the target data, and parsing the received list parameter part comprises at least one of the following:
in response to failing to receive a current list parameter part, receiving a next list parameter part;
in response to failing to parse a currently received list parameter part, parsing a next received list parameter part.

15. The non-transitory storage medium of claim 14, wherein the acts further comprise:
in response to failing to receive or failing to parse a list parameter part, generating a data obtaining request based on the list parameter part that is failed to be received and/or failed to be parsed;
sending the data obtaining request to a target server, to cause the target server to feed back new target data.

16. The non-transitory storage medium of claim 13, wherein the page content corresponding to the target data comprises at least one of a text, an image, an audio, or a video.

17. A non-transitory storage medium comprising computer-executable instructions, wherein the computer-executable instructions, when executed by a computer processor, are configured to implement acts comprising:
in response to a received data obtaining request, generating target data comprising a header parameter part and at least one list parameter part, wherein the header parameter part comprises a general parameter and a target object of a predefined list type;
transmitting the header parameter part to a requesting terminal of the data obtaining request;
in response to completing the transmission of the head parameter part, transmitting the at least one list parameter part to the request terminal.

18. A non-transitory storage medium comprising computer-executable instructions, wherein the computer-executable instructions, when executed by a computer processor, are configured to implement acts comprising:
generating a content obtaining request based on a general parameter and at least one set of list parameters in a target object of a predefined list type, wherein the general parameter and the target object are obtained by parsing a header parameter part of received target data, and the at least one set of list parameters are obtained based on at least one list parameter part of the target data;
sending a content obtaining request to a target server, to cause the target server to feed back corresponding content data;
receiving the content data, and rendering the content data into a page for display.
